(19) United States
(12) Patent Application Publication
(10) Pub. No.: US 2015/0377062 A1
(43) Pub. Date: Dec. 31, 2015

(54) METHOD FOR DETECTING, AVOIDING AND/OR LIMITING CRITICAL OPERATING STATES OF AN EXHAUST GAS TURBOCHARGER

(71) Applicant: BorgWarner Inc., Auburn Hills, MI (US)

(72) Inventors: Philip Parma, Rheinboellen (DE); Rolf Sauerstein, Finkenbach-Gersweiler (DE); Christian Fritz, Herren-Sulzbach (DE)

(21) Appl. No.: 14/750,124

(22) Filed: Jun. 25, 2015

(30) Foreign Application Priority Data
Jun. 26, 2014 (DE) 102014212358.5

(51) Int. Cl. F01D 21/00; F01D 25/16; F01D 5/02

(52) U.S. Cl. CPC F01D 21/003; F01D 5/02; F01D 25/16; F05D 2220/40; F05D 2260/83

(57) ABSTRACT

A method for detecting, avoiding and/or limiting critical operating states of an exhaust gas turbocharger which is operatively connected to a control unit, with the following method steps:
a) estimating calculation of an axial thrust (F_{AX}) on the basis of geometric variables of the exhaust gas turbocharger (1) and on the basis of signals and controlled variables of the control unit (2);
b) determining a current load of an axial bearing (9) of a charger shaft (8) of the exhaust gas turbocharger (1) on the basis of the calculated axial thrust (F_{AX});
and
c) if appropriate, executing control interventions as a function of the determined axial bearing load.

### CROSS-REFERENCE TO RELATED APPLICATIONS

This application claims the benefit of German Patent Application No. 102014212358.5 filed Jun. 26, 2014, the disclosure of which is herein incorporated by reference in its entirety.

### BACKGROUND OF THE INVENTION

1. Field of the Invention

The invention relates to a method for detecting, avoiding and/or limiting critical operating states of an exhaust gas turbocharger, and to an exhaust gas turbocharger useful in executing the method.

2. Description of the Related Art

An exhaust gas turbocharger of the generic type has, as is customary, a charger shaft which has the turbine wheel and the compressor wheel at its ends and which is guided by means of a bearing arrangement in the bearing housing. This bearing arrangement usually has both radial bearings and an axial bearing to which an axial thrust is applied, which said axial bearing takes up.

However, owing to this axial thrust as well as owing to further thermal and mechanical loads which can occur during the operation of an exhaust gas turbocharger, critical operating states may occur which can lead to overloading of the axial bearing and therefore to damage extending as far as the failure of the exhaust gas turbocharger.

Investigations carried out within the scope of the invention have shown that by storing compressor characteristic diagrams and turbine characteristic diagrams in the engine control unit of the engine in which the exhaust gas turbocharger is used, diagnostic possibilities of the exhaust gas turbocharger are also possible, but the axial thrust explained above as well as other thermal and mechanical use boundaries which can be calculated or derived are not taken into account here.

The object of the present invention is therefore to provide a method for detecting, avoiding and/or limiting critical operating states of an exhaust gas turbocharger with which it is possible to determine at least the axial thrust on the axial bearing.

### BRIEF SUMMARY OF THE INVENTION

According to the invention, an estimated calculation of the axial thrust is made on the basis of geometric exhaust gas turbocharger variables and on the basis of signals and controlled variables which originate from a control unit, in particular from the engine control unit. The current loading of an axial bearing of the exhaust gas turbocharger can therefore be detected, and if appropriate control interventions can be performed in order, if possible, to prevent critical operating states occurring at all. The possible control interventions include:
opening a control element such as, for example, a variable turbine geometry or a waste gate valve in order to reduce the pressure losses;
reducing valve overlaps of the outlet valve opening times and inlet valve opening times (referred to colloquially as scavenging); and
changing the air/fuel ratio.

This advantageously ensures that the exhaust gas turbocharger can be operated more at its power limits, which in turn provides the advantage that reserves and safety margins can be reduced.

It is therefore possible, for example, to use the method according to the invention also to diagnose the exhaust gas turbocharger, wherein critical operating states can be detected, limited and, in the best case, avoided in conjunction with further influencing variables such as, in particular, the oil pressure and a DPF regeneration.

The calculations can be carried out directly here or by means of mathematical depiction of the turbocharger in the engine control unit and used.

It is therefore possible to implement the method according to the invention either in a separate control unit which is assigned to the turbocharger, or to provide this implementation in the engine control unit which the engine in which the inventive exhaust gas turbocharger is used has in any case.

It is therefore also possible to support the engine control actively in order to permit the exhaust gas turbocharger also to be operated more closely to its power limits.

An exhaust gas turbocharger according to the invention is defined in claims 8 to 11.

DE 11 2007 001 160 T5 discloses an arrangement for an internal combustion engine and a turbocharger which can be operated with variable load values, and with the internal combustion engine and the turbocharger being arranged in a vehicle. This arrangement comprises a control unit for receiving information about the loading of the turbocharger and for detecting different component damage values, of which it is assumed that they arise on the turbocharger when it is subjected to different loading. However, the axial thrust and the resulting current loading of an axial bearing of the charger shaft of the exhaust gas turbocharger are not taken into account.

U.S. Pat. No. 7,181,959 B2 also discloses a method for determining the level of fatigue, but said method does not begin until a specific rotational speed of the charger is exceeded. However, in reaction to this a reduction of the loading is not proposed but instead an alarm signal is output when the wear limit is reached. Therefore, in this method the turbocharger can nevertheless fail and accordingly critical loading such as, for example, the loading of an axial bearing cannot be avoided.

### BRIEF DESCRIPTION OF THE SEVERAL VIEWS OF THE DRAWINGS

Further details, features and advantages of the invention emerge from the following description of an exemplary embodiment with reference to the drawing, in which:

FIG. 1 shows a perspective sectional illustration of a possible embodiment of an exhaust gas turbocharger according to the invention;

FIG. 2 shows a schematically simplified illustration of a rotor with a charger shaft and compressor wheel and turbine wheel mounted thereon, for explaining the influencing variables, in particular for the calculation of the axial thrust;

FIGS. 3A and 3B show a flowchart explaining the method according to the invention; and

FIG. 4 shows a schematically highly simplified basic outline of a possible embodiment of the control unit of the exhaust gas turbocharger according to the invention.

### DETAILED DESCRIPTION OF THE INVENTION

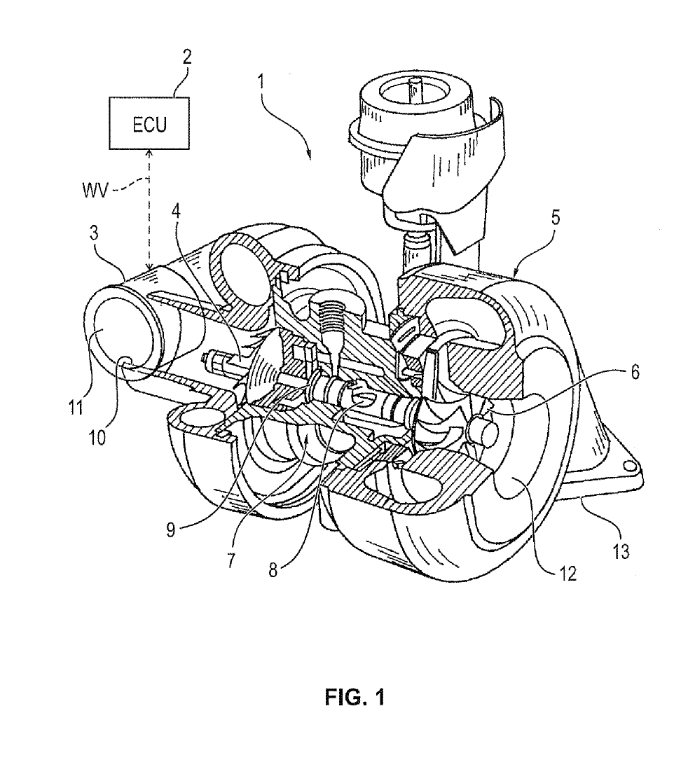

FIG. 1 shows a perspective sectional illustration of an exhaust gas turbocharger 1 according to the invention, which exhaust gas turbocharger 1 is operatively connected to a control unit 2 which can be a control unit which is assigned to the exhaust gas turbocharger 1 or an engine control unit of the engine in which the exhaust gas turbocharger is implemented. If said control unit is the engine control unit, it is identified below by the letters “ECU”.

The exhaust gas turbocharger 1 has a compressor with a compressor housing 3 and a compressor wheel 4 which is arranged therein and is mounted on one end of a charger shaft 8.

In addition, the exhaust gas turbocharger 1 has a turbine which has a turbine housing 5 and a turbine wheel 6 which is arranged therein and is mounted on the other end of the charger shaft 8.

The charger shaft 8 is mounted in a bearing housing 7, for which purpose an axial bearing 9 is provided in addition to a radial bearing system.

In addition, in FIG. 1, the compressor inlet 10 and the compressor outlet 11 as well as the turbine inlet 13 and the turbine outlet 12 are identified by corresponding reference numbers.

In addition, in FIG. 1 the operative connection between the exhaust gas turbocharger 1 and the control unit 2 is symbolized by the double arrow WV.

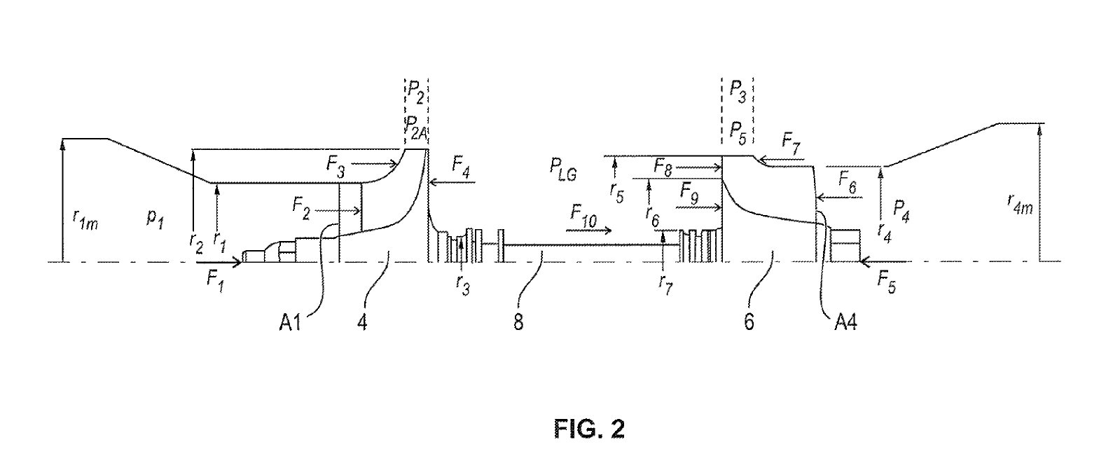

FIG. 2 shows a schematically simplified illustration of a rotor which exhibits the charger shaft 8 and the compressor wheel 4 mounted at one end and the turbine wheel 6 mounted at the other end, wherein only the upper half of this rotor arrangement is illustrated.

In addition, FIG. 2 shows forces and geometric variables which are necessary for the calculation of the axial thrust which is to be explained below.

The concept of the axial thrust calculation, the calculation of the forces and of the pressures, are explained below under sections 1 to 3:

1. Concept of the Axial Thrust Calculation

The calculation of the axial thrust is carried out by means of a simplified axial thrust calculation model which calculates the axial thrust on the basis of geometric variables, the turbocharger rotational speed, the oil pressure and the pressures respectively upstream and downstream of the compressor and the turbine.

The oil pressure p_{LG} in the bearing housing of the turbocharger can be approximated to the engine (not illustrated) by means of a rotational-speed-dependent polynomial, or can be estimated by means of a constant value of for example 1.07 bar. The turbocharger rotational speed is read out, for example, in the engine control unit to sufficient accuracy by means of stored characteristic diagrams, with the result that all the variables for the calculation are available. The use of separate control units which are assigned to the turbocharger 1 is also possible.

2. Calculation of Axial Thrust in the Control Unit, in Particular the ECU Control Unit

FIG. 2 illustrates the pressures p, diameter d and forces F which are necessary for the calculation of the axial thrust.

For this calculation, the sign convention is defined such that a negative force points in the direction of the compressor wheel 4 and a positive force in the direction of the turbine wheel 6. The calculation now follows on the next pages. For the sake of better understanding, the calculation of the forces is illustrated first and then that of the pressures which result in the forces.

Calculation of the Forces

For the calculation of the forces, firstly the principle of linear momentum of fluid mechanics is set out for the compressor and for the turbine.

The calculation of the forces which act on the compressor wheel 4 is documented firstly:

$$\begin{matrix}{F}_{1} = {A}_{1} {p}_{1} = π {r}_{1}^{2} {p}_{1} & ( 1 ) \\ {F}_{2} = {\dot{m}}_{V} {v}_{Air} = \frac{{\dot{m}}_{V} {R}_{Air} {T}_{1}}{π {r}_{1}^{2} {p}_{1}} & ( 2 ) \\ {F}_{3} = \frac{{p}_{1} + {p}_{2 A}}{2} π ( {r}_{2}^{2} - {r}_{1}^{2} ) & ( 3 ) \\ {F}_{4} = - π {a}_{0 V} {p}_{2 A} ln ( 1 + \frac{{r}_{2}^{2} - {r}_{3}^{2}}{{a}_{0 V}} ) & ( 4 )\end{matrix}$$

The forces F5 and F9 act on the turbine wheel 6 and are considered below:

$$\begin{matrix}{F}_{5} = - {A}_{4} {p}_{4} = - {p}_{4} π {r}_{4}^{2} & ( 5 ) \\ {F}_{6} = - {\dot{m}}_{T} {v}_{exgas} = - {\dot{m}}_{T}^{2} {R}_{exgas} \frac{{T}_{4}}{π {r}_{4}^{2} {p}_{4}} & ( 6 ) \\ {F}_{7} = - \frac{{p}_{4} + {p}_{5}}{2} π ( {r}_{5}^{2} - {r}_{4}^{2} ) & ( 7 ) \\ {F}_{8} = [ {p}_{5} - {ρ}_{5} {ω}^{2} ( \frac{{r}_{5}^{2} - {r}_{4}^{2}}{4} ) ] π ( {r}_{5}^{2} - {r}_{4}^{2} ) \\ where \\ ω = \frac{π n}{30} & ( 8 ) \\ {F}_{9} = π {a}_{0 T} {p}_{6} ln ( 1 + \frac{{r}_{6}^{2} - {r}_{7}^{2}}{{a}_{0 T}} ) & ( 9 )\end{matrix}$$

The calculation of the force F₁₀ which occurs in the bearing housing 7 is dependent on the oil pressure in the bearing housing 7, which is estimated in most cases with p_{LG}=1.07 bar:

F₁₀=p_{LG}π(r₇²−r₃²) (10)

The axial thrust is calculated now from the sum of the 10 individual forces according to the equation (11):

Fₐₓ=Σᵢ₌₁¹⁰Fᵢ (11)

3. Calculation of the Pressures

The pressures from the measurement are input into the calculation of the forces described above, said pressures also being described in more detail here. Analogously to the forces, the pressures on the compressor side will be dealt with first.

The measured pressure p₁ₘ in the sample must firstly be converted to the pressure at the pressure inlet 10 (cf. equation (12)) using the Bernoulli equation. The following assumptions are made for this conversion:
the flow is steady-state
the flow is not subject to friction
no heat losses occur
the flow is non-compressible
the flow is swirl-free
air is an ideal gas

$${p}_{1} = {p}_{1 m} + {\dot{m}}_{V} {R}_{air} \frac{{T}_{1}}{2 {p}_{1 m}} [ \frac{1}{{( π {r}_{1 m}^{2} )}^{2}} - \frac{1}{{( π {r}_{1}^{2} )}^{2}} ] \qquad ( 12 )$$

The pressure at the compressor outlet 11 is calculated by means of the equation (13):

$${p}_{2 A} = {{p}_{1} [ {r}_{V} ( {π}_{V}^{\frac{{y}_{V} - 1}{{y}_{V}}} - 1 ) + ]}^{\frac{{y}_{V}}{{y}_{V} - 1}} \\ where \\ {r}_{V} = 0.65 \qquad ( 13 )$$

Equation (14) is used to convert the pressure at the turbine outlet 12 from p₄ₘ at the measuring point to the pressure p₄ for the calculation:

$${p}_{4} = {p}_{4 m} + {\dot{m}}_{T} {R}_{exgas} \frac{{T}_{4}}{2 {p}_{4 m}} [ \frac{1}{{( π {r}_{4 m}^{2} )}^{2}} - \frac{1}{{( π {r}_{4}^{2} )}^{2}} ] \qquad ( 14 )$$

The pressure p₅ at the turbine inlet 13 is estimated by means of the equation (15):

$${p}_{5} = {{p}_{4} [ {r}_{T} ( {π}_{T}^{\frac{{y}_{T} - 1}{{y}_{T}}} - 1 ) + 1 ]}^{\frac{{y}_{T}}{{y}_{T} - 1}} \qquad ( 15 )$$

For the calculation of the pressure p₅, the degree of reaction of the turbine 5, 6 is required. The degree of reaction can be calculated either by means of the equation (17) or can be set to a constant value:

γ_{γ}0.059u₅^{0.295}e^{1.6πu}^{₅}^{-0.369} (17)

The pressure downstream of the turbine wheel 6 is calculated according to the equation (18):

$${p}_{6} = {p}_{5} - \frac{{ρ}_{5}}{2} {ω}^{2} ( {r}_{5}^{2} - {r}_{6}^{2} ) \qquad ( 18 )$$

For the equation (18), the density of the exhaust gas is required, this being calculated by means of equation (19):

$${ρ}_{5} = \frac{{p}_{4}}{{T}_{4} {R}_{exgas}} {( \frac{{p}_{5}}{{p}_{4}} )}^{\frac{1}{{y}_{T}}} \qquad ( 19 )$$

The pressure ratios for compressor 3, 4 and turbine are calculated as follows:

$$\begin{matrix}{π}_{V} = \frac{{p}_{2}}{{p}_{1}} & ( 20 ) \\ {π}_{T} = \frac{{p}_{3}}{{p}_{4}} & ( 21 )\end{matrix}$$

If the turbine outlet temperature has not also been measured, it can also be estimated by means of the following equation:

$${T}_{4} = {T}_{3} [ 1 - {η}_{is , T} ( 1 - {π}_{T}^{- \frac{{y}_{T} - 1}{{y}_{T}}} ) ] , \qquad ( 22 )$$

wherein the turbine efficiency is estimated with η_{is,T}=0.55, which is sufficiently accurate for most calculations.

In order to calculate the forces for equations (4) and (9), coefficients (the unit of the coefficients m²) are required which are shown below:

$$\begin{matrix}{a}_{0 V} = 2 {p}_{2 A} {R}_{air} \frac{{T}_{1}}{{{p}_{1} ( \frac{{p}_{2 A}}{{p}_{1}} )}^{\frac{1}{{y}_{1}}} {ω}_{m}} \\ where \\ {ω}_{m} = 0.5 ω & ( 23 ) \\ {a}_{0 T} = 2 \frac{{p}_{5}}{{ω}_{m}^{2} {ρ}_{5}} & ( 24 )\end{matrix}$$

On pages 14 and 15 there is a list of the variables and values used in the formulae (1-24) above.

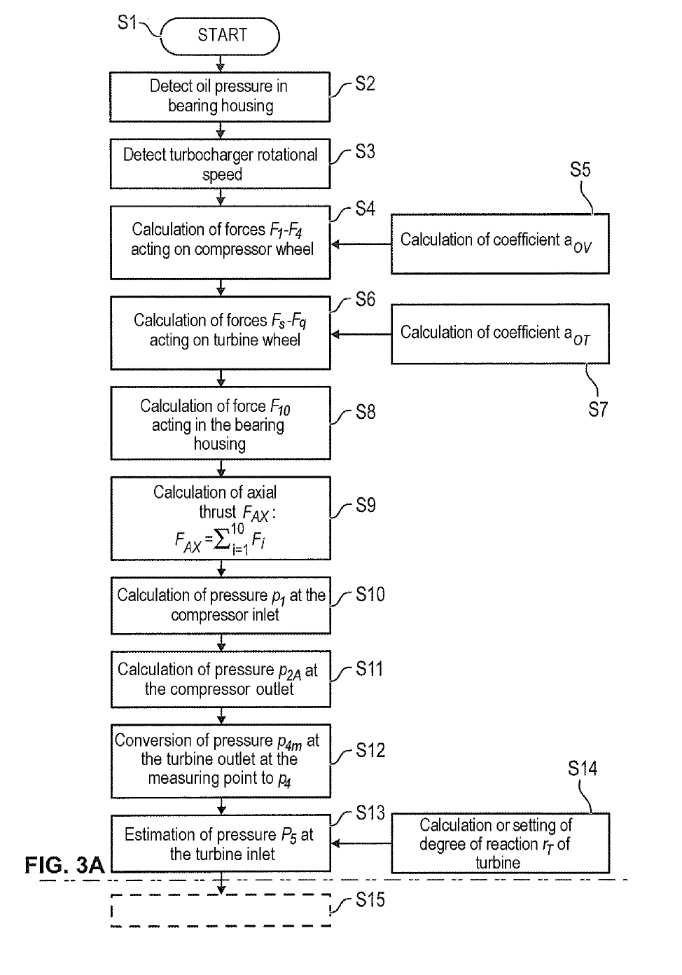

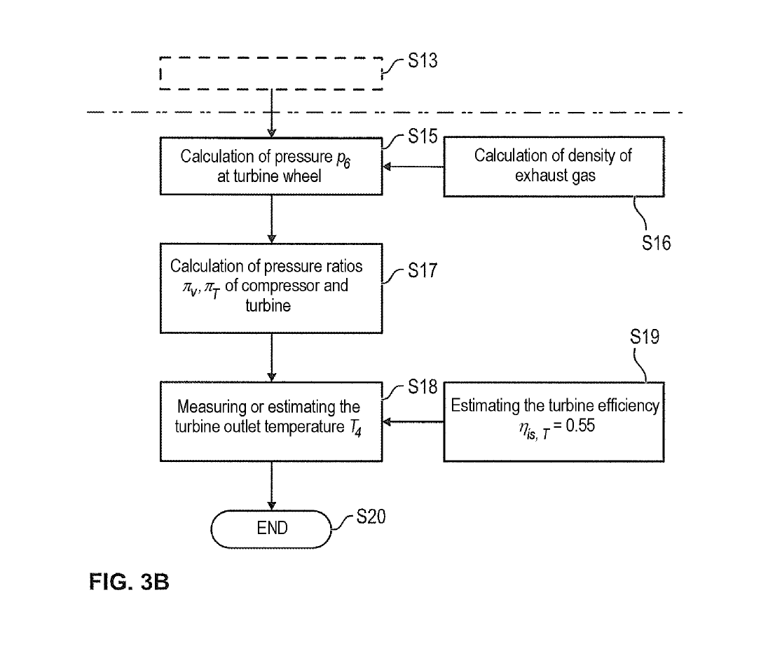

FIGS. 3A and 3B illustrate a flowchart explaining the principles of the method according to the invention.

After the start of the program in step S1 the oil pressure in the bearing housing is detected in step S2.

The turbocharger rotational speed is detected in method step S3.

In step S4, the forces F1 to F4 which act on the compressor wheel are calculated, wherein the coefficient aₒᵥ (unit of the square meter coefficient) which are necessary for the calculation of these forces is calculated in step S5, and taken into account in the calculation of the forces F1 to F4 in step S4.

In step S6, the calculation of the forces F5 to F9 acting on the turbine wheel is carried out. The coefficient a_{OT} necessary to calculate the force F9 is calculated here in step S7 and taken into account in step S6.

In the method step S8, the force F10 occurring in the bearing housing 7 is calculated, said force F10 being dependent on the oil pressure in the bearing housing, which oil pressure can be estimated in most cases with p_{LG}=1.07 bar.

In the method step S9, the axial thrust, which is the sum of the ten individual forces F1 to F10, is calculated.

In the method step S10, the pressure p₁ is calculated at the compressor inlet 10, wherein the measured pressure p_{1M} in the sample is converted to the pressure p₁ at the compressor inlet 10 using the Bernoulli equation.

In the method step S11, the pressure pea at the compressor outlet 11 is calculated, and in the method step S12 the pressure at the turbine outlet 12 is converted from p_{4M} at the measuring point to the pressure p₄ for the calculation in accordance with the equation (14).

The pressure p₅ at the turbine inlet 13 is estimated in the method step S13, wherein the degree of reaction R_{T} of the turbine is calculated or set in step S14, and is taken into account in the estimation of the pressure p₅ in the method step S13.

In the method step S15, the pressure p₆ at the turbine wheel is calculated taking into account the calculation of the density of the exhaust gases, wherein the density of the exhaust gases is calculated in the method step S16.

In the method step S17, the pressure ratios p_{V}, p_{T} at the compressor and at the turbine are calculated. If the turbine outlet temperature has not been measured, it can be estimated in the method step S18, wherein the turbine efficiency N_{IST} is usually estimated with a value of 0.55 and taken into account in the execution of the method step S18. The method according to the invention ends in step S20.

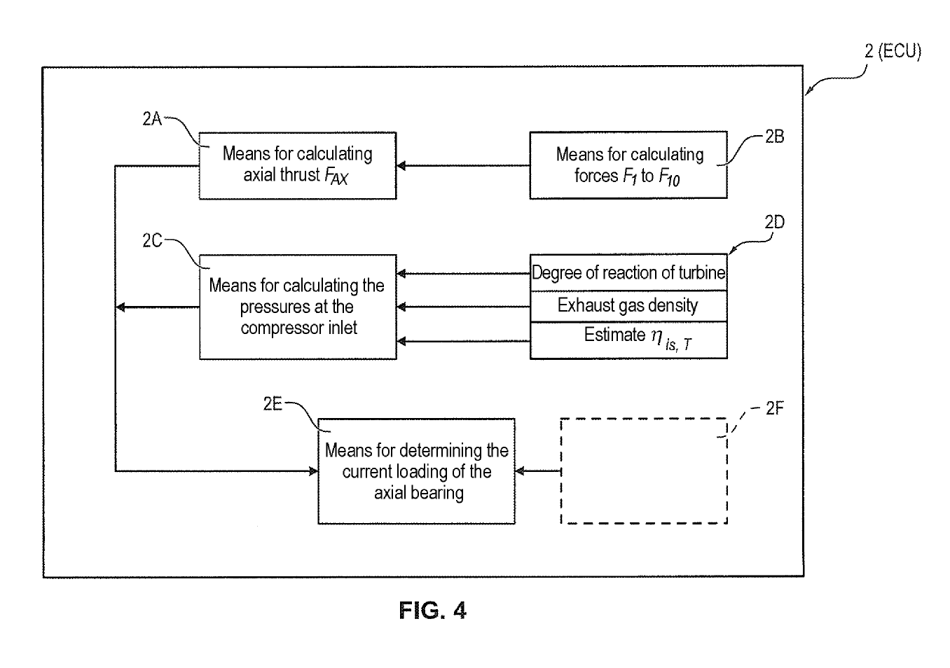

FIG. 4 illustrates a schematically highly simplified illustration of a possible embodiment of the control unit 2 or ECU. Accordingly, this control unit has two means 2A for calculating the axial thrust F_{HX}, which are operatively connected to means 2B for determining the forces F1 to F10 explained above.

In addition, the control unit has two means 2C for calculating the pressures p₁ to p₆ according to the equations explained above and the method steps S10 to S15 explained above. In order to be able to take into account in this calculation the degree of reaction of the turbine according to method step S14, the density of the exhaust gases in accordance with method step S16 and the turbine efficiency according to method step S19, the control unit 2 has correspondingly embodied means 2B. Finally, the control unit has means for determining the current loading of the axial bearing, which means are symbolized by the block 2E in FIG. 4.

As is also illustrated by FIG. 4, the control unit (2) can optionally have means for determining further influencing variables, in particular the oil pressure (p_{LG}) in the bearing housing (7) and/or the DPF regeneration, for determining critical operating states which are symbolized by the dashed block 2F in FIG. 4.

In addition to the written disclosure of the invention above, reference is made explicitly to the figurative illustration of the invention in FIGS. 1 and 4.

### LIST OF REFERENCE SYMBOLS

1 Exhaust gas turbocharger
2 Control unit (ECU)
2A-2F Means/devices of the control unit 2
3 Compressor housing
4 Compressor wheel
5 Turbine housing
6 Turbine wheel
7 Bearing housing
8 Charger shaft
9 Axial bearing
10 Compressor inlet
11 Compressor outlet
12 Turbine outlet
13 Turbine inlet
WV Operative connection
S1-S20 Method steps

Measurement Variables and Calculation Variables

| Name | Unit | Description |
|---|---|---|
| a_{OT} | m²/s | Parameter |
| aₒᵥ | m²/s | Parameter |
| η_{is, T} | | Isentropic turbine efficiency |
| F1 | N | Force |
| F10 | N | Force |
| F2 | N | Force |
| F3 | N | Force |
| F4 | N | Force |
| F5 | N | Force |
| F6 | N | Force |
| F7 | N | Force |
| F8 | N | Force |
| F9 | N | Force |
| yᵥ | | Isentropic exponent compressor |
| y_{T} | | Isentropic exponent turbine |
| m_{pktT} | kg/s | Mass flow turbine |
| m_{pktV} | kg/s | Mass flow compressor |
| ω | 1/s | Angular speed of rotor |
| p₁ | Pa | Pressure at compressor wheel inlet |
| p₁ₘ | Pa | Pressure at measuring point at compressor |
| | | inlet |
| p₂ | Pa | Pressure at compressor outlet |
| p_{2A} | Pa | Pressure at compressor wheel outlet |
| p₃ | Pa | Pressure at turbine inlet |
| p₄ | Pa | Pressure at turbine outlet |
| p₄ₘ | Pa | Pressure at measuring point at turbine wheel |
| | | outlet |
| p₅ | Pa | Pressure at turbine inlet |
| p₆ | Pa | Pressure downstream of turbine wheel |
| pᵢᵥ | Pa | Pressure ratio of compressor |
| p_{iT} | Pa | Pressure ratio of turbine |
| p_{LG} | Pa | Pressure in bearing housing |
| r_{exhaust gas} | J/(kg · K) | Ideal gas constant of exhaust gas |
| rₐᵢᵣ | J/(kg · K) | Ideal gas constant of air |
| r_{T} | | Degree of reaction of turbine |
| rv | | Degree of reaction of compressor |
| p₅ | kg/m³ | Density of exhaust gas |
| T1 | ° C. | Compressor inlet temperature |
| T3 | ° C. | Turbine inlet temperature |
| T4 | ° C. | Turbine outlet temperature |
| u₅ | 1/s | Circumference speed of turbine with respect |
| | | to d5 |
| v_{exhaust gas} | m/s | Speed of exhaust gas (at inlet of turbine) |
| vₐᵢᵣ | m/s | Speed of air (at inlet of compressor) |
| A1 | mm² | Area |
| A4 | mm² | Area |
| r₁ | mm | Compressor wheel inlet radius |
| r₁ₘ | mm | Radius of measuring point at compressor inlet |
| r₂ | mm | Compressor wheel outlet radius |
| r₃ | mm | Sealing ring radius of compressor |
| r₄ | mm | Turbine wheel outlet radius |
| r₄ₘ | mm | Radius of measuring point at turbine outlet |
| r₅ | mm | Turbine wheel inlet radius |
| r₆ | mm | Turbine wheel rear radius |
| r₇ | mm | Sealing ring radius of turbine |

1. A method for detecting, avoiding and/or limiting critical operating states of an exhaust gas turbocharger (1) which is operatively connected (WV) to a control unit (2), comprising the following method steps:
a) estimated calculation of an axial thrust (F_{AX}) on the basis of geometric variables of the exhaust gas turbocharger (1) and on the basis of signals and controlled variables of the control unit (2);
b) determining a current load of an axial bearing (9) of a charger shaft (8) of the exhaust gas turbocharger (1) on the basis of the calculated axial thrust (F_{AX});
and
c) if appropriate, executing control interventions as a function of the determined axial bearing load.

2. The method as claimed in claim 1, defined by the following method step:
d) determining further influencing variables, in particular of an oil pressure (p_{LG}) in the bearing housing (7), in order to determine critical operating states.

3. The method as claimed in claim 1, defined by executing the method steps a), b), c) and/or d) directly at the exhaust gas turbocharger (1).

4. The method as claimed in claim 1, defined by executing the method steps a), b), c) and/or d) by means of mathematical depiction of the exhaust gas turbocharger (1) in the control unit (2).

5. The method as claimed in claim 1, defined by the use of the method steps a), b), c) and/or d) for performing fault diagnosis of the exhaust gas turbocharger.

6. The method as claimed in claim 1, wherein an engine control unit (ECU) of the engine in which the exhaust gas turbocharger (1) is installed is used as the control unit (2).

7. The method as claimed in claim 1, wherein a separate control unit (2) is provided which is assigned to the exhaust gas turbocharger (1).

8. An exhaust gas turbocharger (1) with
a compressor which has a compressor housing (3) and a compressor wheel (4) arranged therein,
a turbine which has a turbine housing (5) and a turbine wheel (6) arranged therein; and
a bearing housing (7) which has at least one axial bearing (9) for supporting a charger shaft (8),
wherein
a control unit (2) is provided which has means (2A to 2E) for carrying out the method steps a) to c) of claim 1.

9. The exhaust gas turbocharger as claimed in claim 8, wherein the control unit (2) has means (2F) for determining further influencing variables for determining critical operating states.

10. The exhaust gas turbocharger as claimed in claim 8, wherein the control unit (2) is an engine control unit (ECU).

11. The exhaust gas turbocharger as claimed in claim 8, wherein a separate control unit (2) assigned to the turbocharger is provided.

12. The exhaust gas turbocharger as claimed in claim 8, wherein the control unit (2) has means (2F) for determining an oil pressure (p_{LG}) in the bearing housing (7) for determining critical operating states.
